(19) United States
(12) Patent Application Publication
(10) Pub. No.: US 2020/0397186 A1
(43) Pub. Date: Dec. 24, 2020

(54) REVERSIBLE HEAT DIFFUSER FOR GAS GRILL

(71) Applicant: Midea Group Co., Ltd., Foshan (CN)

(72) Inventor: Richard W. Cowan, Louisville, KY (US)

(21) Appl. No.: 16/448,764

(22) Filed: Jun. 21, 2019

(51) Int. Cl. A47J 37/07

(52) U.S. Cl. CPC A47J 37/0786; A47J 37/0713

(57) ABSTRACT

A heat diffuser for a grill may include a rigid plate having a first side and a second side and is designed to be positioned between the grilling surface and the burner of a grill, where each the first and second side includes a plurality of diffusing surfaces that when facing the grilling surface are oriented to diffuse heat generated by the burner. The heat diffuser may also include first and second supports located at opposite ends of the rigid plate and configured to support the rigid plate between the grilling surface and the burner in each of first and second orientations, where in the first orientation the first side of the rigid plate faces the grilling surface and in the second orientation the second side of the rigid plate faces the grilling surface.

### BACKGROUND

Heat diffusers on gas grills, which are also occasionally referred to as flame tamers or flavorizer bars, may perform several functions. First, as their name suggests, heat diffusers may distribute the heat generated by the gas burner(s). They may also shield the gas burner(s) from liquids (e.g. grease, sauces, or the like) dripping onto the burner(s) and plugging the burner ports and/or putting out the flames. Heat diffusers may also function to prevent flame flare-ups by quickly burning any liquid that drips onto them. Finally, they may add flavor to the food being cooked by vaporizing the liquid that falls onto them. Conventional heat diffusers are typically V-shaped bars that cover a length of a tubular burner. In some instances, these conventional heat diffusers may be repositionable from front-to-back; however, they are generally designed with a defined top side and a defined bottom side, and are configured to be installed only in an upright (top side up) configuration.

Furthermore, heat diffusers may accumulate burned-on grease, sauces, or other material that falls from food being grilled; because of this, they may become dirty after only a short period of use, and in many instances, are generally difficult to clean. There exists a need for a heat diffuser that is easier to clean and/or requires less frequent cleaning.

### SUMMARY

The herein-described embodiments address these and other problems associated with the art by providing a reversible heat diffuser for a grill. In one aspect, such a heat diffuser designed for use in a grill that includes a grilling surface located over a burner, includes: a rigid plate having a first side and a second side and configured to be positioned between the grilling surface and the burner, where each of the first and the second sides includes a plurality of diffusing surfaces that when facing the grilling surface are oriented to diffuse heat generated by the burner; and first and second supports located near opposite ends of the rigid plate and configured to support the rigid plate between the grilling surface and the burner in each of first and second orientations, where in the first orientation the first side of the rigid plate faces the grilling surface and in the second orientation the second side of the rigid plate faces the grilling surface.

In some embodiments, the first and second supports each include a first slot being capable of receiving a pin coupled to the grill when the rigid plate is in the first orientation and a second slot being capable of receiving the pin when the rigid plate is in the second orientation. In some such embodiments, the first slot and the second slot are symmetrical across an axis running the opposite ends of the rigid plate. In other embodiments, the first and second supports are vertical plates extending transversely to the rigid plate.

In some embodiments, the plurality of diffusing surfaces of the first side of the rigid plate define a first profile that when facing the grilling surface includes a first generally planar surface extending generally parallel to the grilling surface and first and second longitudinally-extending peaks extending along opposite sides of the first generally planar surface, and the plurality of diffusing surfaces of the second side of the rigid plate define a second profile that when facing the grilling surface includes a second generally planar surface extending generally parallel to the grilling surface and first and second longitudinally-extending valleys extending along opposite sides of the second generally planar surface. In some such embodiments, the rigid plate includes a planar sheet bent along first, second, third and fourth longitudinally-extending fold lines, wherein the rigid plate includes a plurality of openings extending through the first and second sides along each of the first, second, third and fourth longitudinally-extending fold lines, where the first longitudinally-extending fold line defines an apex of the first longitudinally-extending peak and a bottom of the first longitudinally-extending valley, the second longitudinally-extending fold line joins the first longitudinally-extending peak with the first generally planar surface and joins the first longitudinally-extending valley with the second generally planar surface, the third longitudinally-extending fold line joins the first generally planar surface with the second longitudinally-extending peak and joins the second generally planar surface with the second longitudinally-extending valley, and the fourth longitudinally-extending fold line defines an apex of the second longitudinally-extending peak and a bottom of the second longitudinally-extending valley. In other such embodiments, the first generally planar surface is a substantially same distance from the grilling surface when the rigid plate is in the first orientation as is the second generally planar surface when the rigid plate is in the second orientation.

In some embodiments, the first longitudinally-extending fold line has an about 90 degree angle when defining an apex of the first longitudinally-extending peak and when defining a bottom of the first longitudinally-extending valley and the fourth longitudinally-extending fold line has an about 90 degree angle when defining an apex of the second longitudinally-extending peak and when defining a bottom of the second longitudinally-extending valley. In other embodiments, the second longitudinally-extending fold line has an about 130 degree angle when joining the first longitudinally-extending peak with the first generally planar surface and when joining the first longitudinally-extending valley with the second generally planar surface and the third longitudinally-extending fold line has an about 130 degree angle when joining the first generally planar surface with the second longitudinally-extending peak and when joining the second generally planar surface with the second longitudinally-extending valley.

In some embodiments, the heat diffusing performance of the heat diffuser is substantially similar in the first orientation and in the second orientation.

In some embodiments, the rigid plate is constructed of a material selected from a group consisting of: cast iron, stainless steel, or enameled steel.

In other aspect, a heat diffuser designed for use in a grill that includes a grilling surface located over a burner, includes: a rigid plate positionable in each of a first orientation and a second orientation, the rigid plate including a plurality of longitudinally-extending segments arranged to diffuse heat generated by the burner when the rigid plate is positioned between the burner and the grilling surface, where in the first orientation the plurality of longitudinally-extending segments define a first profile facing the grilling surface and including a first generally planar surface extending generally parallel to the grilling surface and first and second longitudinally-extending peaks extending along opposite sides of the first generally planar surface, and where in the second orientation the plurality of longitudinally-extending segments define a second profile facing the grilling surface and including a second generally planar surface extending generally parallel to the grilling surface and first and second longitudinally-extending v alleys extending along opposite sides of the second generally planar surface.

In some embodiments, the heat diffuser additionally includes first and second supports located near opposite ends of the rigid plate and configured to support the rigid plate between the grilling surface and the burner in each of first and second orientations. In some such embodiments, the first and second supports each include a first slot being capable of receiving a pin coupled to the grill when the rigid plate is in the first orientation and a second slot being capable of receiving the pin when the rigid plate is in the second orientation. In some embodiments, the first slot and the second slot are symmetrical across an axis running the opposite ends of the rigid plate. In other embodiments, the first and second supports are vertical plates extending transversely to the rigid plate.

In some embodiments, the rigid plate comprises a planar sheet bent along first, second, third and fourth longitudinally-extending fold lines, where the rigid plate includes a plurality of openings extending through the first and second sides along each of the first, second, third and fourth longitudinally-extending fold lines, where the first longitudinally-extending fold line defines an apex of the first longitudinally-extending peak and a bottom of the first longitudinally-extending valley, the second longitudinally-extending fold line joins the first longitudinally-extending peak with the first generally planar surface and joins the first longitudinally-extending valley with the second generally planar surface, the third longitudinally-extending fold line joins the first generally planar surface with the second longitudinally-extending peak and joins the second generally planar surface with the second longitudinally-extending valley, and the fourth longitudinally-extending fold line defines an apex of the second longitudinally-extending peak and a bottom of the second longitudinally-extending valley.

In some embodiments, the first generally planar surface is a substantially same distance from the grilling surface when the rigid plate is in the first orientation as is the second generally planar surface when the rigid plate is in the second orientation. In some embodiments, the first longitudinally-extending fold line has an about 90 degree angle when defining an apex of the first longitudinally-extending peak and when defining a bottom of the first longitudinally-extending valley and the fourth longitudinally-extending fold line has an about 90 degree angle when defining an apex of the second longitudinally-extending peak and when defining a bottom of the second longitudinally-extending valley. In other embodiments, the second longitudinally-extending fold line has an about 130 degree angle when joining the first longitudinally-extending peak with the first generally planar surface and when joining the first longitudinally-extending valley with the second generally planar surface and the third longitudinally-extending fold line has an about 130 degree angle when joining the first generally planar surface with the second longitudinally-extending peak and when joining the second generally planar surface with the second longitudinally-extending valley.

In some embodiments, the heat diffusing performance of the heat diffuser is substantially similar in the first orientation and in the second orientation.

In yet another aspect, a grill described herein includes: one or more gas burners; a grilling surface disposed above the one or more burners; one or more heat diffusers, each positioned between the one or more gas burner and the grilling surface, wherein each of the one or more heat diffusers includes: a rigid plate having a first side and a second side and configured to be positioned between the grilling surface and the burner, where each of the first and the second sides includes a plurality of diffusing surfaces that when facing the grilling surface are oriented to diffuse heat generated by the burner; and first and second supports disposed proximate opposite ends of the rigid plate and configured to support the rigid plate between the grilling surface and the burner in each of first and second orientations, wherein in the first orientation the first side of the rigid plate faces the grilling surface and in the second orientation the second side of the rigid plate faces the grilling surface.

In some embodiments, the first and second supports are vertical plates extending transversely to the rigid plate.

In some embodiments, the plurality of diffusing surfaces of the first side of the rigid plate define a first profile facing the grilling surface include a first generally planar surface extending generally parallel to the grilling surface and first and second longitudinally-extending peaks extending along opposite sides of the first generally planar surface, and wherein the plurality of diffusing surfaces of the second side of the rigid lace define a second profile that when facing the grilling surface include a second generally planar surface extending generally parallel to the grilling surface and first and second longitudinally-extending valleys extending along opposite sides of the second generally planar surface. In some embodiments, the first generally planar surface is a substantially same distance from the grilling surface when the rigid plate is in the first orientation as is the second generally planar surface when the rigid plate is in the second orientation.

In some embodiments, the heat diffusing performance of the heat diffuser is substantially similar in the first orientation and in the second orientation.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a grill consistent with some embodiments of the invention.

FIG. 2 is a perspective view of a heat diffuser for a grill consistent with some embodiments of the invention.

FIGS. 3A-B are cross-sectional views of the heat diffuser taken along line 3 of FIG. 2. FIG. 3A is a cross-sectional view of the heat diffuser of FIG. 2 in a first orientation; and FIG. 3B is a cross-sectional view of the heat diffuser of FIG. 2 in a second orientation.

FIG. 4 is a cross-sectional elevation view of the grill of FIG. 1 with a plurality of the heat diffusers of FIG. 2.

### DETAILED DESCRIPTION

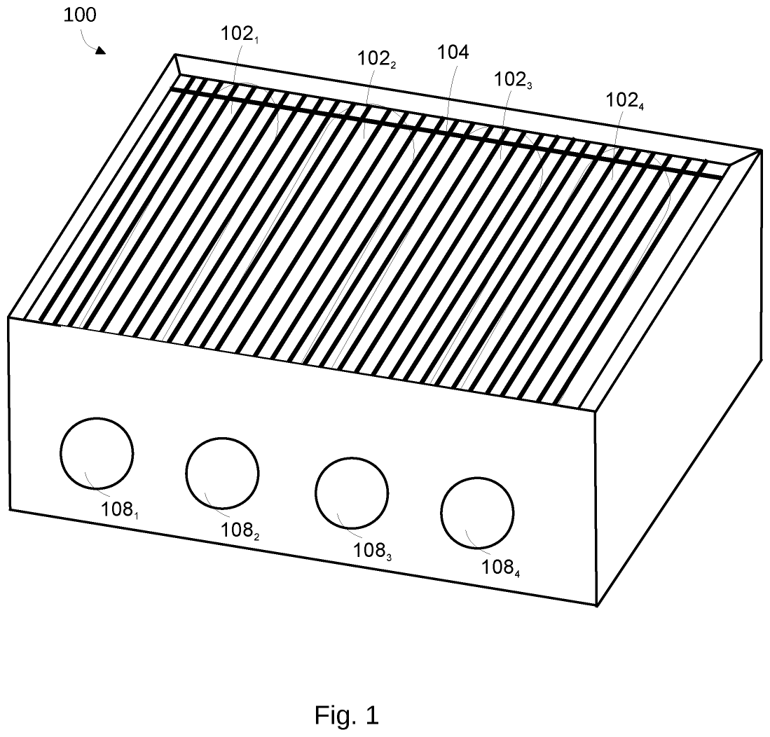

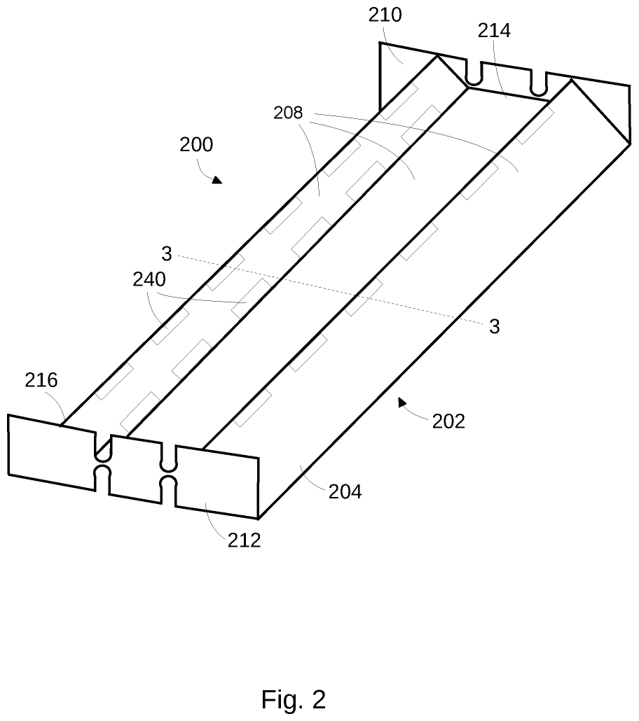

Turning now to the drawings, wherein like numbers denote like parts throughout the several views, FIG. 1 illustrates an example grill 100 with which the heat diffuser 200 (see FIGS. 2-4) described herein may be used. Such a grill 100 may include one or more cylindrical, tubular burners 102₁₋ₙ, corresponding controls 108₁₋ₙ for each burner₁₋ₙ, and a grilling surface 104 disposed over the burners 102₁₋ₙ. Grill 100 may be any type of gas grill, and may vary in size, design, etc. For example, as illustrated in FIG. 1, grill 100 has four burners 102₁₋₄, but this is not to be construed as limiting, as grill 100 may have more, or fewer, burners depending on the cooking capacity of the grill 100. The grilling surface 104 may be in the form of a grate, such as illustrated in FIG. 1; such a grate may be constructed of a variety of materials, including but not limited to, cast iron, porcelain-coated cast iron, stainless steel, porcelain-coated steel, or steel. The number and size of these grilling surfaces 104 may also vary depending on the cooking capacity of the grill 100. For example, there may be a single grilling surface 104, or grate, for all burners 102, or there may be multiples grilling surfaces 104. One or more heat diffusers 200 (see FIGS. 2-4) may be installed above the burner(s) 102 and below the grilling surface 104.

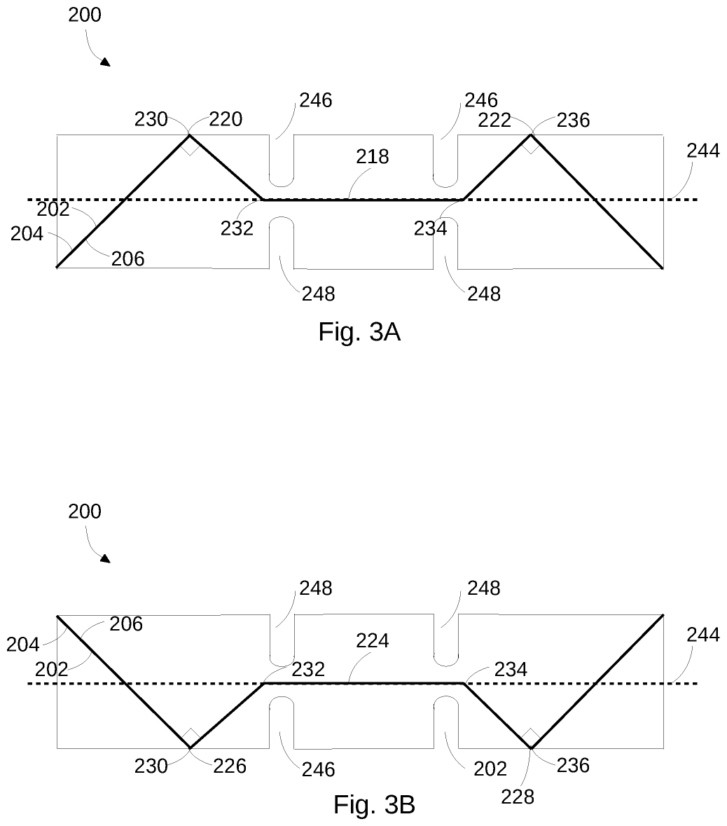

Referring now to FIGS. 2-4, which illustrate an example heat diffuser 200 for use with a gas grill, such as grill 100 illustrated in FIG. 1. FIG. 2 illustrates a perspective view of such a heat diffuser 200, which may include a rigid plate 202 that may be positioned between the grilling surface 104 and the burner 102 when placed within the grill 100. This rigid plate 202 may be constructed of any number of heat-safe materials known in the art, including but not limited to, cast iron, stainless steel, enameled steel, etc. The rigid plate 202, as best illustrated in FIGS. 3A-B, may include a first side 204 and a second side 206, each of which may include a plurality of diffusing surfaces 208 that when facing the grilling surface 104 may diffuse heat generated by the burner 102. The rigid plate 202 may be reversible so that either the first side 204 or the second side 206 may be “right-side up” or facing the grilling surface when placed within the grill. This reversibility may, in some instances, lengthen the time period between cleanings of the heat diffuser 200.

In some instances, the heat diffuser 200 may also include a plurality of openings 240 that extend through the first 204 and second 206 sides that allow heat generated by the burner(s) 102 to rise through the openings 240 for ventilation. In addition to ventilation, the positioning of the openings 240 may also allow for any liquid that may drop off the food item being cooked on the grilling surface to drain. The ends 214, 216 of the rigid plate 202 of the heat diffuser 200 may also include a first support 210 and a second support 212 for coupling and supporting the rigid plate 202 to the grill 100 in each orientation described herein. Supports 210, 212 will be discussed in greater detail below.

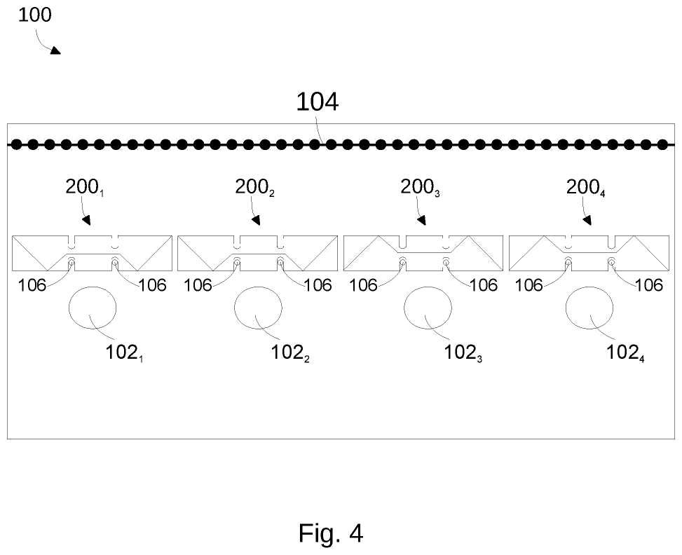

Referring now specifically to FIGS. 3A-B, these figures illustrate cross-sectional views of the heat diffuser 200 in a first orientation (FIG. 3A) and in a second orientation (FIG. 3B). Although not illustrated in FIGS. 3A-B, it is to be understood the heat diffuser 200 is illustrated in the position in which it would be within the grill, such that a burner would be disposed below the heat diffuser 200 and a grilling surface above the heat diffuser 200 (for example see FIG. 4). In the first orientation (FIG. 3A) the first side 204 of the rigid plate 202 faces the grilling surface, and while in the second orientation (FIG. 3B) the rigid plate 202 is reversed so that the second side 206 of the rigid plate 202 faces the grilling surface. The diffusing surfaces 208 of the first side 204 of the rigid plate 202 may define a first profile (see FIG. 3A) of the rigid plate 202. The first profile, when facing the grilling surface, may include a first generally planar surface 218 extending generally parallel to the grilling surface and first 220 and second 222 longitudinally-extending peaks that extend along opposite sides of the first generally planar surface 218. The diffusing surfaces 208 of the second side 206 of the rigid plate 202 may define a second profile (see FIG. 3B) of the rigid plate. The second profile, when facing the grilling surface, may include a second generally planar surface 224 extending generally parallel to the grilling surface and first 226 and second 228 longitudinally-extending valleys that extend along opposite sides of the second generally planar surface 224.

In some instances, the rigid plate 202 may be constructed of multiple sheets of material, for example by welding (or otherwise connecting) segments together to form the first and second profiles illustrated in FIGS. 3A-B. In other instances, the rigid plate 202 may be constructed of a single planar sheet bent that is along multiple longitudinally-extending fold lines in order to form the first and second profiles illustrated in FIGS. 3A-B, respectively. For example, the rigid plate 202 may include first 230, second 232, third 234, and fourth 236 longitudinally-extending fold lines. In some instances, the plurality of openings 240 (see FIG. 2) that extend through the first 204 and second 206 sides may be along each of the first 230, second 232, third 234, and fourth 236 longitudinally-extending fold lines. The first longitudinally-extending fold line 230 may define an apex of the first longitudinally-extending peak 220 and a bottom of the first longitudinally-extending valley 226, depending on whether the rigid plate 202 is in the first orientation (FIG. 3A) or the second orientation (FIG. 3B). The second longitudinally-extending fold line 232 may join the first longitudinally-extending peak 220 with the first generally planar surface 218 and may join the first longitudinally-extending valley 226 with the second generally planar surface 224, depending on whether the rigid plate 202 is in the first orientation (FIG. 3A) or the second orientation (FIG. 3B). The third longitudinally-extending fold line 234 may join the first generally planar surface 218 with the second longitudinally-extending peak 222 and may join the second generally planar surface 224 with the second longitudinally-extending valley 228, depending on whether the rigid plate 202 is in the first orientation (FIG. 3A) or the second orientation (FIG. 3B). Finally, the fourth longitudinally-extending fold line 326 may define an apex of the second longitudinally-extending peak 222 and a bottom of the second longitudinally-extending valley 228, depending on whether the rigid plate 202 is in the first orientation (FIG. 3A) or the second orientation (FIG. 3B).

The angles of the longitudinally-extending fold lines 230, 232, 234, 236 may vary. As described herein, all angles will be described and referenced by their less than 180 degree counterpart. In some instances, the first longitudinally-extending fold line 230 may be at an about 90 degree angle when defining an apex of the first longitudinally-extending peak 220 or when defining a bottom of the first longitudinally-extending valley 226. Similarly, the fourth longitudinally-extending fold line 236 may also be at an about 90 degree angle when defining an apex of the second longitudinally-extending peak 222 or when defining a bottom of the second longitudinally-extending valley 228.

In some instances, the second longitudinally-extending fold line 232 may be at an about 130 degree angle when joining the first longitudinally-extending peak 220 with the first generally planar surface 218 or when joining the first longitudinally-extending valley 226 with the second generally planar surface 224. Similarly, the third longitudinally-extending fold line 234 may be at an about 130 degree angle when joining the first generally planar surface 218 with the second longitudinally-extending peak 222 or when joining the second generally planar surface 224 with the second longitudinally-extending valley 228. It is to be understood that the angle measurements provided herein are merely exemplary and are not to be construed as limiting.

Focusing now on the first 210 and second 212 supports, these supports 210 and 212 are positioned at opposing ends 214, 216 of the rigid plate 202. In some instances, for example as illustrated in FIGS. 2-4, the first 210 and second 212 supports may each be implemented using a vertical plate that extends transverse to the rigid plate 202. In some instances, these plates may be constructed of the same material as the rigid plate 202; while in other instances, these plates be constructed of a different material. In other instances the first 210 and second 212 supports may each include one or more first slots 246 that may be able to receive one or more pins 106 (see FIG. 4) coupled to the grill 100 when the rigid plate 202 is in the first orientation and one or more second slots 248 that may also be able to receive the pin 106 (see FIG. 4) when the rigid plate 202 is in the second orientation. The slot 246, 248 and pin 106 combination may support the placement of the rigid plate 202 within the grill. In some instances, such as illustrated in FIGS. 2-4, the slots 246, 248 may be disposed on the vertical plates; however, this is not intended to be limiting, as other structures may be used to support a heat diffuser in other embodiments, and even in some embodiments, the supports may be integrated into the rigid plate itself. Furthermore, while a slot/pin arrangement is used in the illustrated embodiment, other engagement structures may be used in other embodiments to support and maintain the relative positioning of a heat diffuser over one or more gas burners. For example, a ledge may be provided around a perimeter of the housing of a grill in some embodiments, and a heat diffuser may simply be supported on the ledge without the need for a pin or additional supporting structure. In other embodiments, the heat diffuser may be supported by the burner itself. In still other embodiments, a plurality of openings or slots may be provided in the grill, where these openings may receive a tab or protrusion extending the heat diffuser to support the heat diffuser.

In the illustrated embodiment, the first slot(s) 246 and second slot(s) 248 may be directly opposed to each other so as to create symmetry across an axis 244 running through the length of the support(s) 210, 212, whereby the heat diffuser will be positioned at the same position relative to the gas burners irrespective of the orientation of the heat diffuser. All of the various supports 210, 212 described herein, as well as others that will be recognized by one of skill in the art, may allow the first 218 and second 224 generally planar surfaces to be a substantially same distance from the grilling surface 104 when the rigid plate 202 is in the first orientation (see FIG. 3A) as well as when the rigid the second orientation (see FIG. 3B). By doing so, and/or by utilizing symmetric arrangements of peaks and valleys, the heat diffuser may, in some embodiments, provide substantially the same performance irrespective of the orientation of the heat diffuser.

Referring now to FIG. 4, this figure illustrates a cross-sectional view of grill 100 with a multiple heat diffusers 200₁₋ₙ installed therein. As illustrated in FIG. 1, grill 100 may include cylindrical, tubular burners 102₁₋ₙ and a grilling surface 104 disposed over the burners 102₁₋ₙ. It will be appreciated, however, that a wide variety of burner designs may be used in other embodiments, e.g., H-shaped, U-shaped, circular, disk-shaped, etc. Each heat diffuser 200₁₋ₙ illustrated in FIG. 4 is disposed directly above a corresponding burner 102₁₋ₙ and below the grilling surface 104. Each heat diffuser 200₁₋ₙ may be reversible so that it may be positioned either in a first orientation (see heat diffusers 200₃, 200₄) or in a second orientation (see heat diffusers 200₁, 200₂). As illustrated in FIG. 4, the heat diffusers 200₁₋ₙ may be at the same vertical position between the burners 102 and the grilling surface 104 (e.g. substantially the same distance from the grilling surface 104) regardless of their orientation. The heat diffusing performance of the heat diffusers 200₁₋ₙ may be substantially similar in the first orientation as it is in the second orientation, so that there is no perceivable difference in cooking quality based on the orientation of the heat diffuser 200. Furthermore, in addition to diffusing heat, as illustrated in FIG. 4, the heat diffusers 200₁₋ₙ may also shield the burners 102₁₋ₙ from drips when positioned in either the first or second orientation.

Although illustrated herein with each burner 102 having its own corresponding heat diffuser 200, this is not to be understood as limiting. In some instances, a single heat diffuser 200 may be disposed over multiple burners 102₁₋ₙ; for example, a single heat diffuser may cover two, or more, burners. Alternatively, multiple heat diffusers may be disposed over a single burner. In the embodiment illustrated in FIG. 4, two of heat diffusers 200₃, 200₄ are positioned in a first orientation, while the other two heat diffusers 200₁, 200₂ are positioned in in a second orientation; however, this is not intended to be limiting as the number of heat diffusers 200 arranged in each orientation may vary. For example, in some instances the heat diffusers 200₁₋ₙ may all be positioned in the same orientation within the grill 100. Regardless of the orientation in which the heat diffuser begins, each heat diffuser 200₁₋ₙ may be reversible, such that it may be repositioned into the opposite orientation. For example, in FIG. 4 heat diffusers 200₃, 200₄ are positioned in a first orientation, but a user may be reversed to be in a second orientation; likewise, in FIG. 4 heat diffusers 200₁, 200₂ are positioned in a second orientation, but a user may be reversed to be in a first orientation. As a non-limiting example, it may be desirable to reverse the orientation of the heat diffuser 200 when the side facing the grilling surface 104 becomes soiled (e.g. from grease, sauces, etc.). Once reversed, the side that originally faced the grilling surface may be exposed directly to the burner(s) 102 beneath, which may allow for burning off the food, grease, sauces, etc. in order to clean the heat diffuser 200; the heat diffuser 200 may then be reversed a second time so that the freshly cleaned side faces the grilling surface 104 again.

It will be appreciated that the heat diffuser profiles illustrated herein may be modified in other embodiments. For example, various arrangements of one or more peaks, one or more valleys, and one or more planar surfaces may be combined in different embodiments, and in other embodiments, one or more curved surfaces may also be used. As but one example, two, three, four or more of heat diffusers 200 may be combined into a single heat diffuser in some embodiments, and in some instances, a single unitary heat diffuser may be used for the entire grilling surface in some embodiments.

It will also be appreciated that various additional modifications may be made to the embodiments discussed herein, and that a number of the concepts disclosed herein may be used in combination with one another or may be used separately. Therefore, the invention lies in the claims hereinafter appended.

What is claimed is:

1. A heat diffuser for a grill of a type including a grilling surface disposed over a burner, comprising:
a rigid plate having a first side and a second side and configured to be positioned between the grilling surface and the burner, wherein each of the first and the second sides includes a plurality of diffusing surfaces that when facing the grilling surface are oriented to diffuse heat generated by the burner; and
first and second supports disposed proximate opposite ends of the rigid plate and configured to support the rigid plate between the grilling surface and the burner in each of first and second orientations, wherein in the first orientation the first side of the rigid plate faces the grilling surface and in the second orientation the second side of the rigid plate faces the grilling surface.

2. The heat diffuser of claim 1, wherein the first and second supports each include a first slot being capable of receiving a pin coupled to the grill when the rigid plate is in the first orientation and a second slot being capable of receiving the pin when the rigid plate is in the second orientation.

3. The heat diffuser of claim 2, wherein the first slot and the second slot are symmetrical across an axis running the opposite ends of the rigid plate.

4. The heat diffuser of claim 1, wherein the plurality of diffusing surfaces of the first side of the rigid plate define a first profile that when facing the grilling surface includes a first generally planar surface extending generally parallel to the grilling surface and first and second longitudinally-extending peaks extending along opposite sides of the first generally planar surface, and wherein the plurality of diffusing surfaces of the second side of the rigid plate define a second profile that when facing the grilling surface includes a second generally planar surface extending generally parallel to the grilling surface and first and second longitudinally-extending valleys extending along opposite sides of the second generally planar surface.

5. The heat diffuser of claim 4, wherein the rigid plate comprises a planar sheet bent along first, second, third and fourth longitudinally-extending fold lines, wherein the rigid plate includes a plurality of openings extending through the first and second sides along each of the first, second, third and fourth longitudinally-extending fold lines, wherein the first longitudinally-extending fold line defines an apex of the first longitudinally-extending peak and a bottom of the first longitudinally-extending valley, the second longitudinally-extending fold line joins the first longitudinally-extending peak with the first generally planar surface and joins the first longitudinally-extending valley with the second generally planar surface, the third longitudinally-extending fold line joins the first generally planar surface with the second longitudinally-extending peak and joins the second generally planar surface with the second longitudinally-extending valley, and the fourth longitudinally-extending fold line defines an apex of the second longitudinally-extending peak and a bottom of the second longitudinally-extending valley.

6. The heat diffuser of claim 4, wherein the first generally planar surface is a substantially same distance from the grilling surface when the rigid plate is in the first orientation as is the second generally planar surface when the rigid plate is in the second orientation.

7. The heat diffuser of claim 1, wherein first and second supports are vertical plates extending transversely to the rigid plate.

8. The heat diffuser of claim 5, wherein the first longitudinally-extending fold line has an about 90 degree angle when defining an apex of the first longitudinally-extending peak and when defining a bottom of the first longitudinally-extending valley and the fourth longitudinally-extending fold line has an about 90 degree angle when defining an apex of the second longitudinally-extending peak and when defining a bottom of the second longitudinally-extending valley.

9. The heat diffuser of claim 8, wherein the second longitudinally-extending fold line has an about 130 degree angle when joining the first longitudinally-extending peak with the first generally planar surface and when joining the first longitudinally-extending valley with the second generally planar surface and the third longitudinally-extending fold line has an about 130 degree angle when joining the first generally planar surface with the second longitudinally-extending peak and when joining the second generally planar surface with the second longitudinally-extending valley.

10. The heat diffuser of claim 1, wherein a heat diffusing performance of the heat diffuser is substantially similar in the first orientation and in the second orientation.

11. The heat diffuser of claim 1, wherein the rigid plate is constructed of a material selected from a group consisting of: cast iron, stainless steel, or enameled steel.

12. A heat diffuser for a grill of a type including a grilling surface disposed over a burner, comprising:
a rigid plate positionable in each of a first orientation and a second orientation, the rigid plate including a plurality of longitudinally-extending segments arranged to diffuse heat generated by the burner when the rigid plate is positioned between the burner and the grilling surface,
wherein in the first orientation the plurality of longitudinally-extending segments define a first profile facing the grilling surface and including a first generally planar surface extending generally parallel to the grilling surface and first and second longitudinally-extending peaks extending along opposite sides of the first generally planar surface, and
wherein in the second orientation the plurality of longitudinally-extending segments define a second profile facing the grilling surface and including a second generally planar surface extending generally parallel to the grilling surface and first and second longitudinally-extending valleys extending along opposite sides of the second generally planar surface.

13. A heat diffuser of claim 12, further comprising first and second supports disposed proximate opposite ends of the rigid plate and configured to support the rigid plate between the grilling surface and the burner in each of first and second orientations.

14. The heat diffuser of claim 13, wherein the first and second supports each include a first slot being capable of receiving a pin coupled to the grill when the rigid plate is in the first orientation and a second slot being capable of receiving the pin when the rigid plate is in the second orientation.

15. The heat diffuser of claim 14, wherein the first slot and the second slot are symmetrical across an axis running the opposite ends of the rigid plate.

16. The heat diffuser of claim 15, wherein the rigid plate comprises a planar sheet bent along first, second, third and fourth longitudinally-extending fold lines, wherein the rigid plate includes a plurality of openings extending through the first and second sides along each of the first, second, third and fourth longitudinally-extending fold lines, wherein the first longitudinally-extending fold line defines an apex of the first longitudinally-extending peak and a bottom of the first longitudinally-extending valley, the second longitudinally-extending fold line joins the first longitudinally-extending peak with the first generally planar surface and joins the first longitudinally-extending valley with the second generally planar surface, the third longitudinally-extending fold line joins the first generally planar surface with the second longitudinally-extending peak and joins the second generally planar surface with the second longitudinally-extending valley, and the fourth longitudinally-extending fold line defines an apex of the second longitudinally-extending peak and a bottom of the second longitudinally-extending valley.

17. The heat diffuser of claim 12, wherein the first generally planar surface is a substantially same distance from the grilling surface when the rigid plate is in the first orientation as is the second generally planar surface when the rigid plate is in the second orientation.

18. The heat diffuser of claim 13, wherein the first and second supports are vertical plates extending transversely to the rigid plate.

19. The heat diffuser of claim 16, the first longitudinally-extending fold line has an about 90 degree angle when defining an apex of the first longitudinally-extending peak and when defining a bottom of the first longitudinally-extending valley and the fourth longitudinally-extending fold line has an about 90 degree angle when defining an apex of the second longitudinally-extending peak and when defining a bottom of the second longitudinally-extending valley.

20. The heat diffuser of claim 19, wherein the second longitudinally-extending fold line has an about 130 degree angle when joining the first longitudinally-extending peak with the first generally planar surface and when joining the first longitudinally-extending valley with the second generally planar surface and the third longitudinally-extending fold line has an about 130 degree angle when joining the first generally planar surface with the second longitudinally-extending peak and when joining the second generally planar surface with the second longitudinally-extending valley.

21. The heat diffuser of claim 12, wherein heat diffusing performance of the heat diffuser is substantially similar in the first orientation and in the second orientation.

22. A grill, comprising:
one or more gas burners;
a grilling surface disposed above the one or more burners;
one or more heat diffusers, each positioned between the one or more gas burner and the grilling surface, wherein each of the one or more heat diffusers includes:
a rigid plate having a first side and a second side and configured to be positioned between the grilling surface and the burner, wherein each of the first and the second sides includes a plurality of diffusing surfaces that when facing the grilling surface are oriented to diffuse heat generated by the burner; and
first and second supports disposed proximate opposite ends of the rigid plate and configured to support the rigid plate between the grilling surface and the burner in each of first and second orientations, wherein in the first orientation the first side of the rigid plate faces the grilling surface and in the second orientation the second side of the rigid plate faces the grilling surface.

23. The grill of claim 22, wherein the first and second supports are vertical plates extending transversely to the rigid plate.

24. The grill of claim 22, wherein the plurality of diffusing surfaces of the first side of the rigid plate define a first profile facing the grilling surface include a first generally planar surface extending generally parallel to the grilling surface and first and second longitudinally-extending peaks extending along opposite sides of the first generally planar surface, and wherein the plurality of diffusing surfaces of the second side of the rigid lace define a second profile that when facing the grilling surface include a second generally planar surface extending generally parallel to the grilling surface and first and second longitudinally-extending valleys extending along opposite sides of the second generally planar surface.

25. The grill of claim 24, wherein the first generally planar surface is a substantially same distance from the grilling surface when the rigid plate is in the first orientation as is the second generally planar surface when the rigid plate is in the second orientation.

26. The grill of claim 22, wherein heat diffusing performance of the heat diffuser is substantially similar in the first orientation and in the second orientation.
